(19) United States
(12) Patent Application Publication
(10) Pub. No.: US 2012/0128197 A1
(43) Pub. Date: May 24, 2012

(54) ELECTRONIC DEVICE WITH CUSHIONED SPEAKER

(75) Inventors: MIN-LI LI, Shenzhen City (CN); TING-TING ZHAO, Shenzhen City (CN); HONG LI, Shenzhen City (CN); XIAO-HUI ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/071,462

(22) Filed: Mar. 24, 2011

(30) Foreign Application Priority Data
Nov. 22, 2010 (CN) 201010553727.4

(51) Int. Cl. H04R 1/02

(52) U.S. Cl. 381/395

(57) ABSTRACT

An exemplary electronic device with a speaker includes a mounting plate, a speaker mounted on the mounting plate, two fasteners mounting the speaker, and a buffer washer squeezed between the mounting plate and the speaker. The buffer washer is capable of absorbing vibration of the speaker. Each of the fasteners includes a head portion and a post portion. The post portion is mounted on the mounting plate and is located outside the speaker. The head portion presses the speaker to abut against the buffer washer.

### BACKGROUND

1. Technical Field

The present disclosure relates to electronic devices, and particularly to an electronic device with a speaker.

2. Description of Related Art

Electronic devices such as notebook computers, game players, and music players are often configured with speakers therein to provide audio output. Such an electronic device at least includes a mounting plate and a speaker mounted thereon. The speaker directly contacts the mounting plate.

During use, the speaker is electrified to vibrate and generate sound. However, the direct contact between the mounting plate and the speaker can generate resonance, degrading the sound quality of the electronic device.

Accordingly, what is needed is an electronic device which can overcome the limitations described.

### BRIEF DESCRIPTION OF THE DRAWINGS

FIG. 1 is an isometric, assembled view of an electronic device in accordance with an exemplary embodiment of the present disclosure.

FIG. 2 is an isometric, exploded view of the electronic device of FIG. 1.

FIG. 3 is an enlarged view of a portion of the electronic device shown in FIG. 2.

FIG. 4 is an enlarged view of a circled portion IV of FIG. 2.

### DETAILED DESCRIPTION

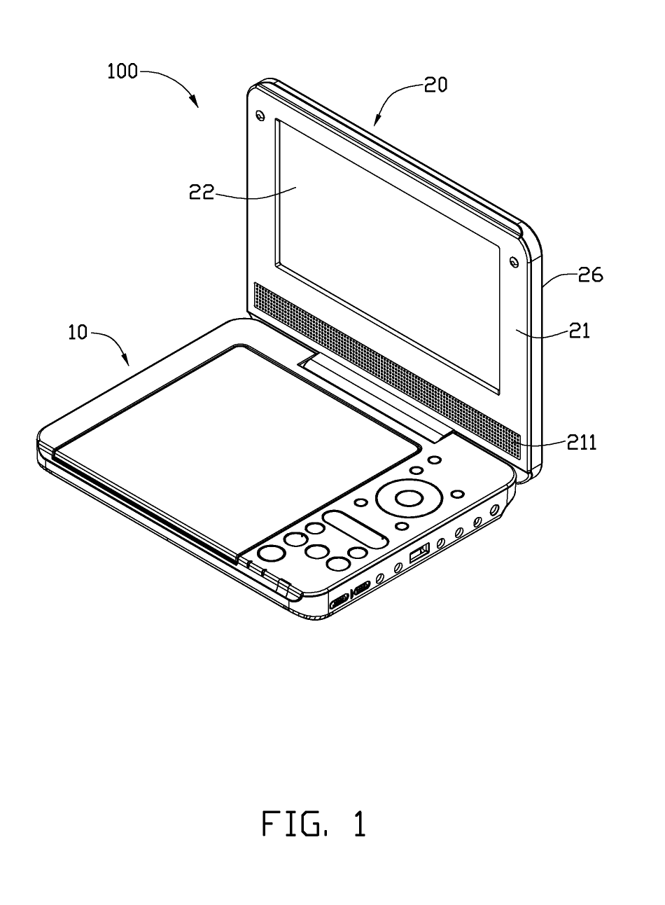

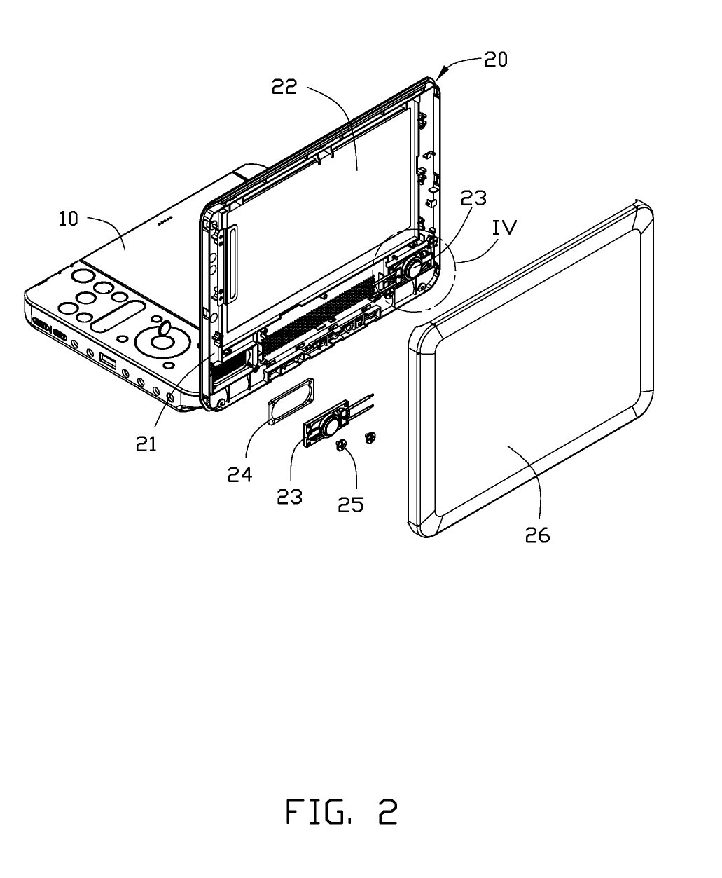

Referring to FIGS. 1-2, an electronic device 100 according to an exemplary embodiment of the present disclosure is shown. In this embodiment, the electronic device 100 is a digital video disc (DVD) player. The electronic device 100 includes a main body 10, and a display portion 20 pivotally connected to a lateral side of the main body 10. The display portion 20 includes a mounting plate 21, a display screen 22 mounted on the mounting plate 21, two speakers 23 mounted on a back surface of the mounting plate 21, two buffer washers 24 respectively mounted between the back surface of the mounting plate 21 and the two speakers 23, a plurality of fasteners 25 for mounting the two speakers 23 on the mounting plate 21, and a cover plate 26 covering the back surface of the mounting plate 21. The two speakers 23 are located below the display screen 22 and respectively at two corners of the mounting plate 21. The mounting plate 21 defines a plurality of sound ports 211 facing the two speakers 23.

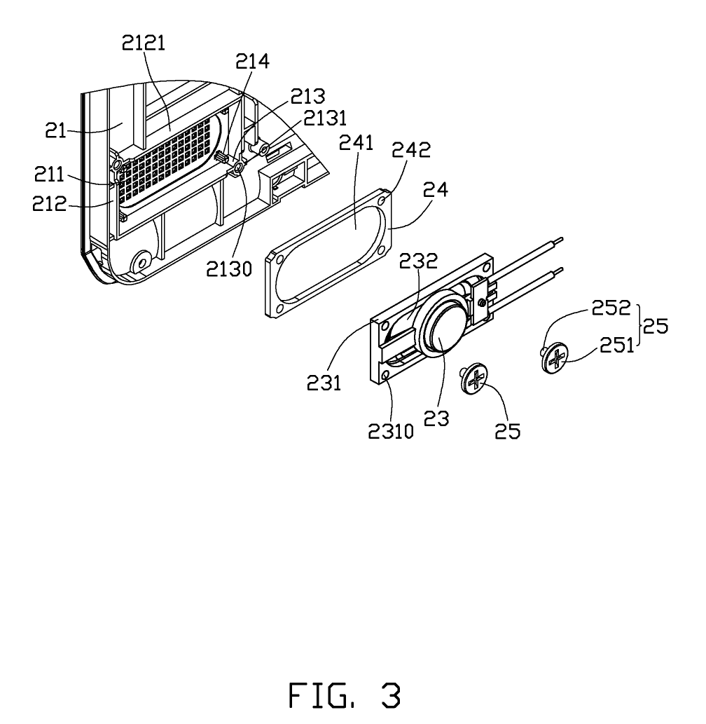

Referring also to FIG. 3, two locating frames 212 protrude outwardly from the back surface of the mounting plate 21, corresponding to the two speakers 23. Each of the two locating frames 212 is rectangular and includes four sidewalls 2121 connecting with each other end to end. Two mounting sleeves 213 are formed at two diagonal corners of the locating frame 212. Two tabs 2131 protrude radially from a periphery of the mounting sleeve 213, with the two tabs 2131 being perpendicular to each other. The tabs 2131 of the mounting sleeves 213 are perpendicular to and connect with the mounting plate 21. The tabs 2131 of the mounting sleeve 213 reinforce the strength of the mounting sleeve 213. The mounting sleeve 213 defines a mounting hole 2132 therein along an axis thereof, and one of the fasteners 25 can be extended into the mounting hole 2132.

Four positioning posts 214 are formed in each of the locating frames 212. The four positioning posts 214 extend outwardly from the mounting plate 21 adjacent to four corners of the locating frame 212. Each of the four positioning posts 214 is spaced apart slightly from the two adjacent sidewalls 2121 of the locating frame 212. Each positioning post 214 has a cross-shaped cross section.

Each of the speakers 23 is rectangular, and includes a rectangular bracket 231 and a vibration component 232 mounted on the bracket 231. The bracket 231 defines four positioning holes 2310 respectively at four corners thereof, corresponding to the four positioning posts 214 of the respective mounting plate 21. The vibration component 232 is located at a center of the bracket 231. The four positioning holes 2310 surround the vibration component 232.

The buffer washer 24 is rectangular and made of resilient material, such as rubber, silica gel, or other, which is capable of absorbing contact vibration. In this embodiment, the buffer washer 24 is silica gel comprising organic siloxane polymer with a Shore hardness of about 70°. The size of the buffer washer 24 is the same as that of the bracket 231 of the corresponding speaker 23. An opening 241 is defined in a center of the buffer washer 24, corresponding to the vibration component 232 of the speaker 23. Four through holes 242 are defined at four corners of the buffer washer 24 respectively, corresponding to the four positioning posts 214 of the respective mounting plate 21. The four through holes 242 surround the opening 241.

Each fastener 25 includes a disk-shaped head portion 251, and a post portion 252 extending outwardly from a center of the head portion 251. A diameter of the head portion 251 exceeds that of the post portion 251.

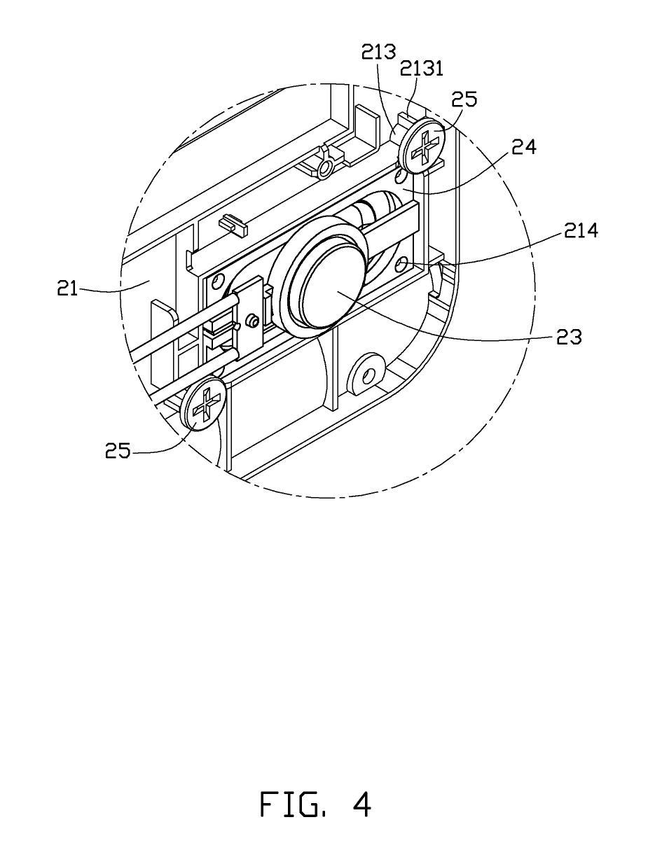

In assembly of the electronic device 100, each buffer washer 24 is positioned in the corresponding locating frame 212. In particular, the positioning posts 214 of the mounting plate 21 respectively extend through the four through holes 242 of the buffer washer 24, so as to preassemble the buffer washer 24 on the mounting plate 21. The speaker 23 is seated in the locating frame 212, with the vibration component 232 facing the mounting plate 21. The four positioning posts 214 of the mounting plate 21 respectively extend through the four positioning holes 2310 of the speaker 23, thereby preassembling the speaker 23 onto the buffer washer 24. Two fasteners 25 are mounted on the mounting plate 21, with the post portions 252 of the fasteners 25 respectively threaded into the mounting sleeves 213 of the mounting plate 21. The post portions 252 of the two fasteners 25 are located outside two opposite lateral sides of the speaker 23, and the head portions 251 of the two fasteners 25 contact the two opposite lateral sides of the speaker 23, as shown in FIG. 4, to abut the speaker 23 on the buffer washer 24. Accordingly, the buffer washer 24 and the speaker 23 are mounted on the mounting plate 21, and the buffer washer 24 is sandwiched or squeezed between the speaker 23 and the mounting plate 21.

In the electronic device 100, each speaker 23 is mounted on the mounting plate 21 through the two fasteners 25 which press the speaker 23 to bias the resilient buffer washer 24, and the buffer washer 24 is squeezed between the speaker 23 and the mounting plate 21. During operation, the vibration component 232 of the speaker 23 is electrified to vibrate to generate sound. At the same time, the bracket 231 of the speaker 23 is driven to vibrate by the vibration component 232. However, the buffer washer 24 absorbs the vibration of the bracket 231 of the speaker 23. Therefore, resonance of the mounting plate 21 is avoided, and the sound quality of the electronic device 100 is improved.

It is to be understood, however, that even though numerous characteristics and advantages of the exemplary embodiments have been set forth in the foregoing description, together with details of the structures and functions of the embodiments, the disclosure is illustrative only, and that changes may be made in detail, especially in matters of shape, size, and arrangement of parts within the principles of the embodiments to the full extent indicated by the broad general meaning of the terms in which the appended claims are expressed.

What is claimed is:

1. An electronic device comprising:
a mounting plate;
a speaker mounted on the mounting plate;
two fasteners for mounting the speaker on the mounting plate, each of the fasteners comprising a head portion and a post portion, the post portion mounted on the mounting plate and located outside the speaker, the head portion pressing on the speaker; and
a buffer washer squeezed between the speaker and the mounting plate, the buffer washer being capable of absorbing vibration of the speaker.

2. The electronic device of claim 1, wherein the buffer washer is made of rubber or silica gel.

3. The electronic device of claim 2, wherein the buffer washer is made of silica gel comprising organic siloxane polymers with a Shore hardness of about 70°.

4. The electronic device of claim 1, wherein the head portion of the faster is disk-shaped, and a diameter of the head portion exceeds that of the post portion.

5. The electronic device of claim 4, wherein two mounting sleeves are formed on the mounting plate, the post portions of the two fasteners are respectively mounted in the two mounting sleeves, and each of the mounting sleeves protrudes at least one tab outwardly from a periphery thereof.

6. The electronic device of claim 5, wherein a locating frame is formed on the mounting plate, the locating frame comprises a plurality of sidewalls connecting with each other end to end, the speaker and the buffer washer are both located in the locating frame, the two mounting sleeves are formed at two diagonal corners of the locating frame respectively, and each of the two mounting sleeves connects with two adjacent sidewalls of the locating frame.

7. The electronic device of claim 1, wherein a plurality of positioning posts are formed in the locating frame, the speaker defines a plurality of positioning holes therein, the buffer washer defines a plurality of through holes therein, and each of the positioning posts extends through a corresponding positioning hole of the speaker and a corresponding through hole of the buffer washer.

8. The electronic device of claim 7, wherein each of the positioning posts has a cross-shaped cross section.

9. The electronic device of claim 7, wherein the buffer washer defines an opening therein, and the through holes of the buffer washer surround the opening.

10. The electronic device of claim 9, wherein the speaker comprises a bracket and a vibration component mounted thereon, the bracket abuts against the buffer washer, and the vibration component is aligned with the opening.

11. An electronic device comprising:
a mounting plate comprising a plurality of positioning posts protruding therefrom;
a speaker mounted on the mounting plate, the speaker comprising a bracket and a vibration component mounted thereon, the bracket defining a plurality of positioning holes, each of the positioning posts extending through a corresponding positioning hole;
two fasteners each comprising a head portion and a post portion, the post portion mounted on the mounting plate and located outside the speaker, the head portion pressing on the bracket of the speaker; and
a buffer washer squeezed between the speaker and the mounting plate, the speaker abutting against the buffer washer, the buffer washer preventing vibration of the bracket of the speaker from transmitting to the mounting plate.

12. The electronic device of claim 11, wherein the buffer washer is made of rubber or silica gel.

13. The electronic device of claim 12, wherein the buffer washer is made of silica gel comprising of organic siloxane polymers with and a Shore hardness of about 70°.

14. The electronic device of claim 11, wherein the head portion of the faster is disk-shaped, and a diameter of the head portion exceeds that of the post portion.

15. The electronic device of claim 14, wherein two mounting sleeves are formed on the mounting plate, the post portions of the two fasteners are respectively mounted in the two mounting sleeves, and each of the mounting sleeves protrudes at least one tab outwardly from a periphery thereof.

16. The electronic device of claim 15, wherein a locating frame is formed on the mounting plate, the locating plate including a plurality of sidewalls connecting with each other from beginning to end, the speaker and the buffer washer are both located in the locating frame, the two mounting sleeves are formed at two diagonal corners of the locating frame respectively, and each of the two mounting sleeves connects with two adjacent sidewalls of the locating frame.

17. The electronic device of claim 11, wherein the buffer washer defines a plurality of through holes therein, and each of the positioning posts extends through a corresponding through hole of the buffer washer.

18. The electronic device of claim 17, wherein the positioning post has a cross-shaped cross section.

19. The electronic device of claim 17, wherein the buffer washer defines an opening therein, the through holes of the buffer washer surround the opening, and the vibration component is aligned with the opening.

20. An electronic device comprising:
a mounting plate;
a buffer washer made of vibration absorbing material;
a speaker comprising a peripheral bracket; and
a plurality of fasteners, each of the fasteners comprising a head portion and a post portion;
wherein a shape of the buffer washer corresponds to a shape of the bracket of the speaker, and the fasteners mount the speaker and the buffer washer on the mounting plate, with the post portions engaged in the mounting plate and located outside the speaker and the head portions pressing on the speaker, such that the fasteners sandwich the buffer washer between the mounting plate and the speaker.
